(19) United States
(12) Patent Application Publication
(10) Pub. No.: US 2012/0195681 A1
(43) Pub. Date: Aug. 2, 2012

(54) STEEL BAR CONNECTOR

(76) Inventors: Chia-Lung CHEN, Taichung City (TW); Jou Lee, Taipei City (TW)

(21) Appl. No.: 13/155,722

(22) Filed: Jun. 8, 2011

(30) Foreign Application Priority Data
Jan. 28, 2011 (TW) 100202083

(51) Int. Cl. F16B 7/00

(52) U.S. Cl. 403/341

(57) ABSTRACT

A steel bar connector includes two adapter members each having an arched inner wall fitting the periphery of two reinforcing steel bars that are abutted end-to-end against each other, inner threads located on the arched inner wall and engaged with the outer threads of the reinforcing bars and a positioning block protruded from the outside wall thereof at one end, and a socket for attaching onto the adapter members to hold down the adapter members and the reinforcing steel bars together. The socket defines two opposing longitudinal ribs protruded from the inside wall thereof, two longitudinal half-round grooves separated by the longitudinal ribs for accommodating the adapter members respectively and a positioning groove located on one end of each longitudinal half-round groove for the engagement with the positioning block of each of the adapter members.

This application claims the priority benefit of Taiwan patent application number 100202083, filed on Jan. 28, 2011.

### BACKGROUND OF THE INVENTION

1. Field of the Invention

The present invention relates to building construction technology and more particularly, to a steel bar connector for joining two reinforcing steel bars in line, which has the advantages of simple structure, ease of installation and low installation cost.

2. Description of the Related Art

Reinforcing steel bars are intensively used in the construction of a reinforced concrete or steel reinforced concrete for bridge or building to join reinforcing steel bars. Due to the limitation of delivery space or job-site space, the length of reinforcing steel bars is controlled within a certain range. Therefore, steel bar connectors may be used to join reinforcing steel bars subject to the desired length during construction.

FIG. 9 illustrates a steel bar connector according to the prior art. According to this design, the steel bar connector comprises a collar A and a plurality of nuts B. The collar A comprises a plurality of teeth A1 located on the inside wall thereof, a plurality of outer threads A2 located on the periphery of each of two opposing tapered end portions A3 thereof, and a plurality of longitudinal crevices A4 cut through the tapered end portions A3. Each nut B comprises a plurality of inner threads B1. During application, the two reinforcing steel bars C to be fastened are inserted through the nuts B and the collar A and abutted end-to-end against each other, and then the nuts B are rotated to force the respective inner threads B1 into engagement with the outer threads A2 at the periphery of each of the two opposing tapered end portions A3 of the collar A and to further keep the teeth A1 in engagement with the rib pattern of the reinforcing steel bars C.

This design of steel bar connector is still not satisfactory in function due to the following drawbacks:

1. The friction resistance between the teeth A1 and the rib pattern of the reinforcing steel bars C is not sufficient, lowering the tensile strength and seismic resistance of the combination structure of the steel bar connector and the reinforcing steel bars C.

2. During installation, the user must rotate the nuts B with much effort to thread the inner threads B1 into engagement with the outer threads A2 at the periphery of each of the two opposing tapered end portions A3 of the collar A. This installation procedure requires much time and labor.

Therefore, it is desirable to provide a steel bar connector, which eliminates the aforesaid drawbacks.

### SUMMARY OF THE INVENTION

The present invention has been accomplished under the circumstances in view. It is the main object of the present invention to provide a steel bar connector for joining two reinforcing steel bars in line, which has the advantages of simple structure, ease of installation and low installation cost.

To achieve this and other objects of the present invention, a steel bar connector is adapted for joining two reinforcing steel bars that are abutted end-to-end. The steel bar connector comprises two adapter members for attaching to the two reinforcing steel bars, and a socket for attaching onto the adapter members to hold down the adapter members and the reinforcing steel bars together. Each adapter member comprises an arched inner wall fitting the periphery of the two reinforcing steel bars, female engagement means, for example, inner threads or ribs located on the arched inner wall and a male positioning means, for example, positioning block located on one end of an outside wall thereof. The socket comprises a longitudinal receiving open chamber extending through opposing front and rear sides thereof, two opposing longitudinal ribs protruded from the inside wall thereof within the longitudinal receiving open chamber, two longitudinal half-round grooves defined in the longitudinal receiving open chamber and separated by the longitudinal ribs and adapted for accommodating the adapter members respectively and female positioning means, for example, positioning groove located on one end of each of the two longitudinal half-round grooves for engagement with the positioning blocks of the adapter members.

### BRIEF DESCRIPTION OF THE DRAWINGS

FIG. 1 is an elevational applied view illustrating a steel bar connector fastened to two abutted reinforcing steel bars in accordance with the present invention.

FIG. 2 is an exploded perspective view of the steel bar connector in accordance with the present invention.

FIG. 3 is a sectional exploded view of the steel bar connector in accordance with the present invention.

FIG. 4 is a sectional installed view of the present invention, illustrating the adapter members attached to the reinforcing steel bars abound the abutment end edges.

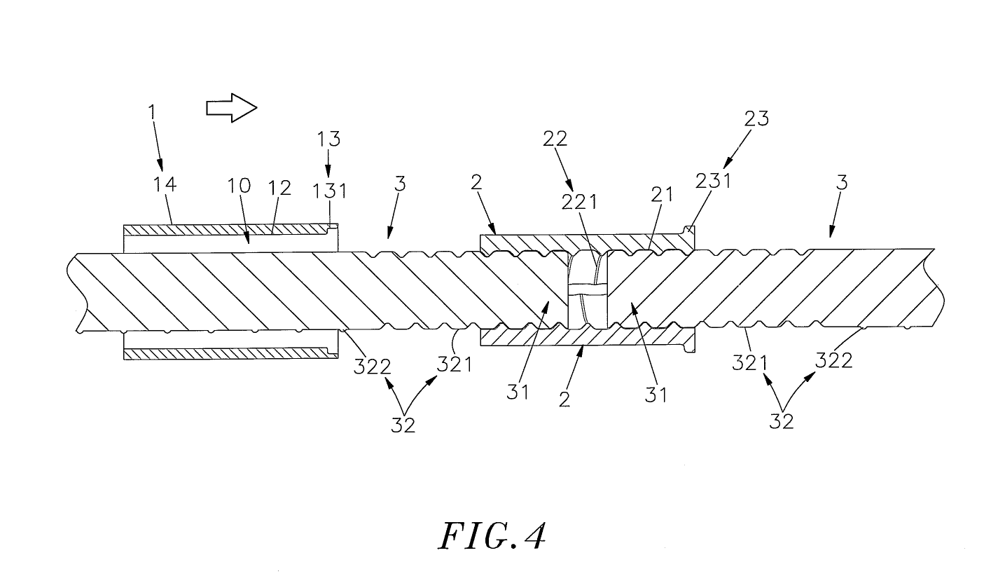

FIG. 5 corresponds to FIG. 4, illustrating the socket fastened to the adapter members.

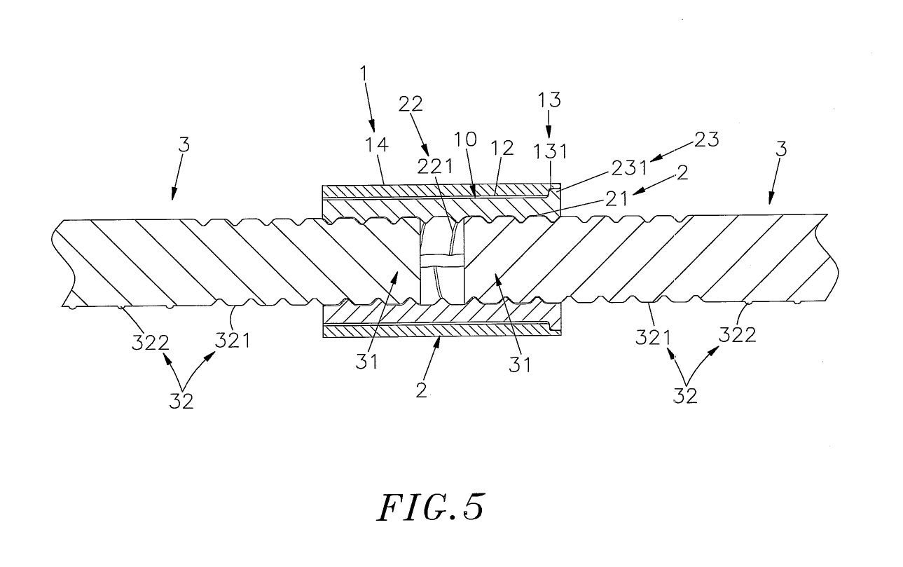

FIG. 6 is a cross sectional view of the present invention, illustrating the socket fastened to the adapter members around the reinforcing steel bars.

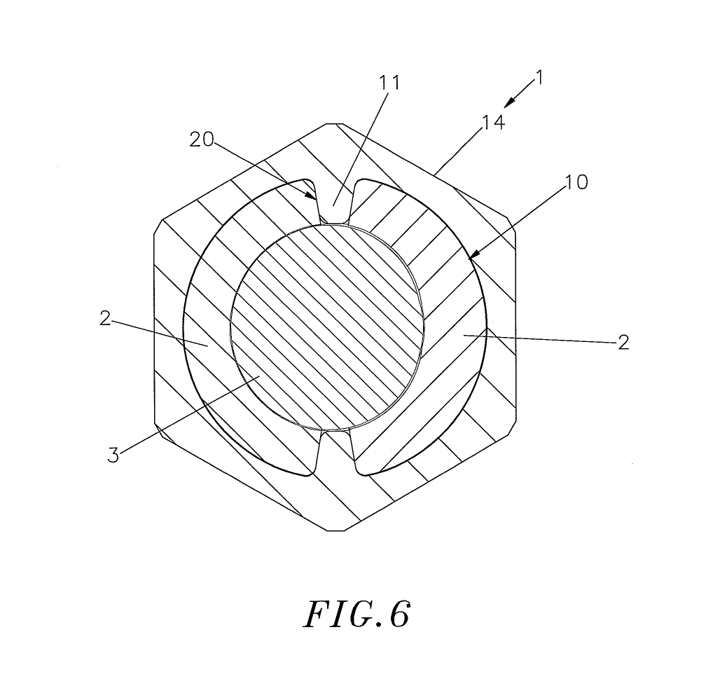

FIG. 7 is a schematic drawing illustrating the use of steel bar connectors in a concrete construction according to the present invention.

FIG. 8 is an exploded perspective view of an alternate form of the steel bar connector in accordance with the present invention.

FIG. 9 is an exploded view of a steel bar connector according to the prior art.

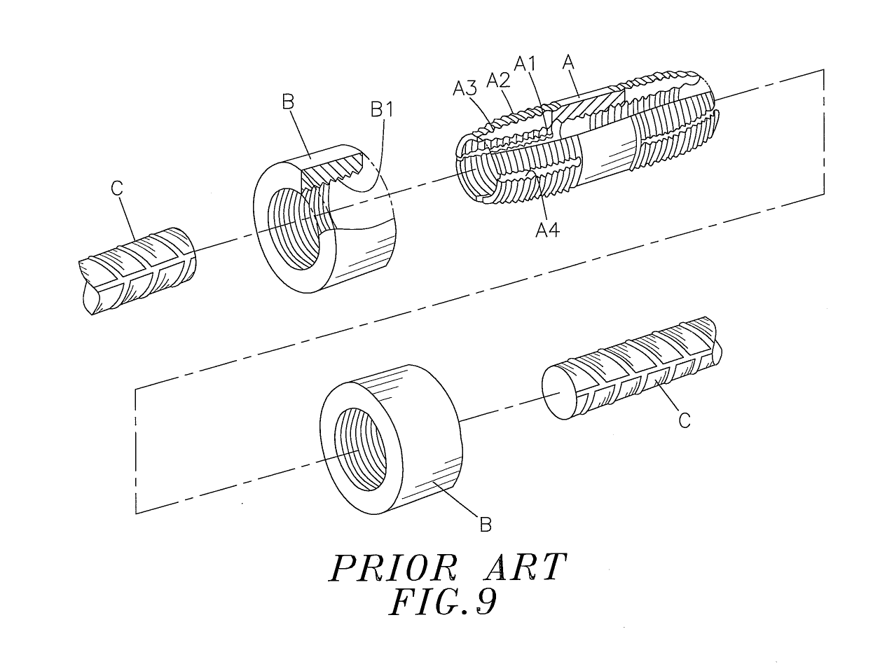

### DETAILED DESCRIPTION OF THE PREFERRED EMBODIMENT

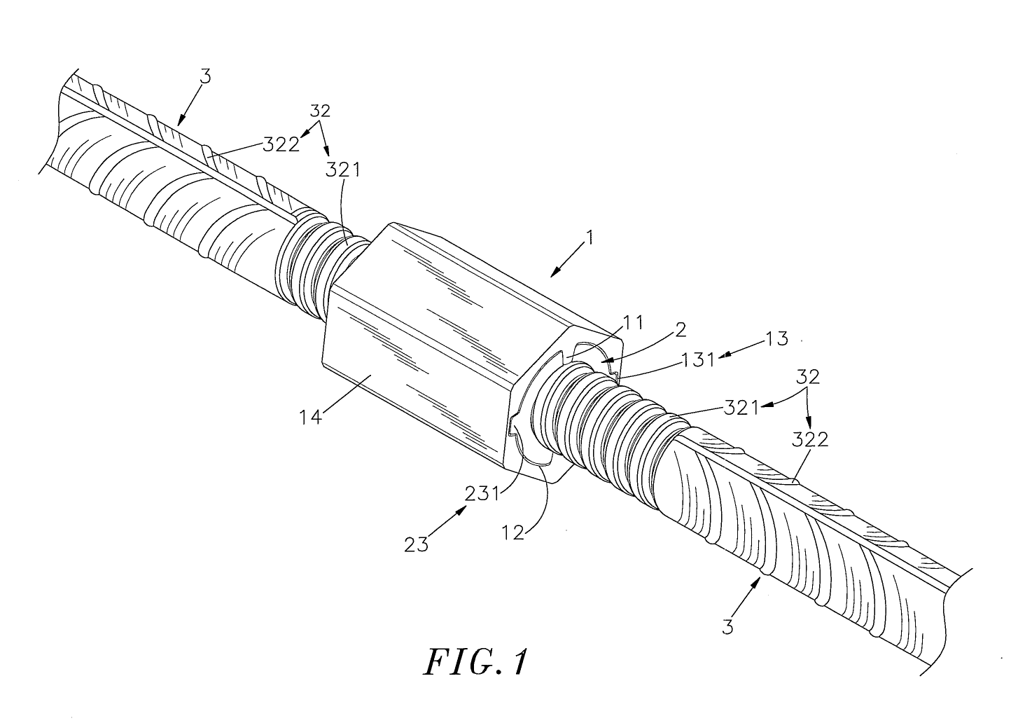

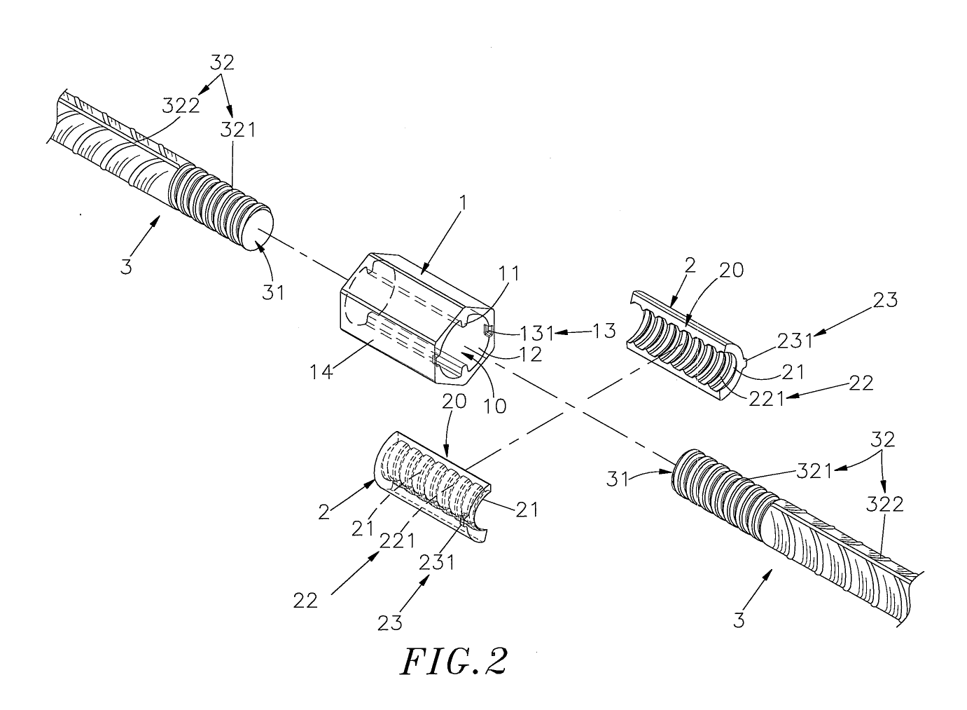

Referring to FIGS. 1 and 2, a steel bar connector in accordance with the present invention is shown joining two reinforcing steel bars 3 in line. The steel bar connector comprises a socket 1 and a plurality of, for example, two adapter members 2.

The socket 1 comprises a longitudinal receiving open chamber 10 extending through opposing front and rear sides thereof, two opposing longitudinal ribs 11 protruded from the inside wall thereof inside the longitudinal receiving open chamber 10, two longitudinal half-round grooves 12 defined in the longitudinal receiving open chamber 10 and separated by the longitudinal ribs 11 and female positioning means 13 at one end of each of the two longitudinal half-round grooves 12.

The adapter members 2 are half round plate members respectively fitted into the longitudinal half-round grooves 12 of the socket 1, each comprising female engagement means 22 located on the arched inner wall 21 thereof and male positioning means 23 located on one end of the outside wall thereof corresponding to one female positioning means 13 of the socket 1.

Further, the reinforcing steel bars 3 to be joined by the steel bar connector in accordance with the present invention comprises a rib pattern 32 arranged around the periphery thereof and an abutment end edge 31 located on one end thereof. The rib pattern 32 comprises a plurality of outer threads 321 disposed adjacent to the abutment end edge 31 and plurality of ribs 322 disposed remote from the abutment end edge 31. Further, in this embodiment, each female positioning means 13 of the socket 1 is a positioning groove 131; the female engagement means 22 comprises a plurality of inner threads 221 for engagement with the outer threads 321 of one reinforcing steel bar 3; the male positioning means 23 of each adapter member 2 is a positioning block 231 fitting one respective positioning groove 131 of the socket 1. Further, the socket 1 can be made in the shape of a polygonal tube, having multiple faces 14 to facilitate gripping.

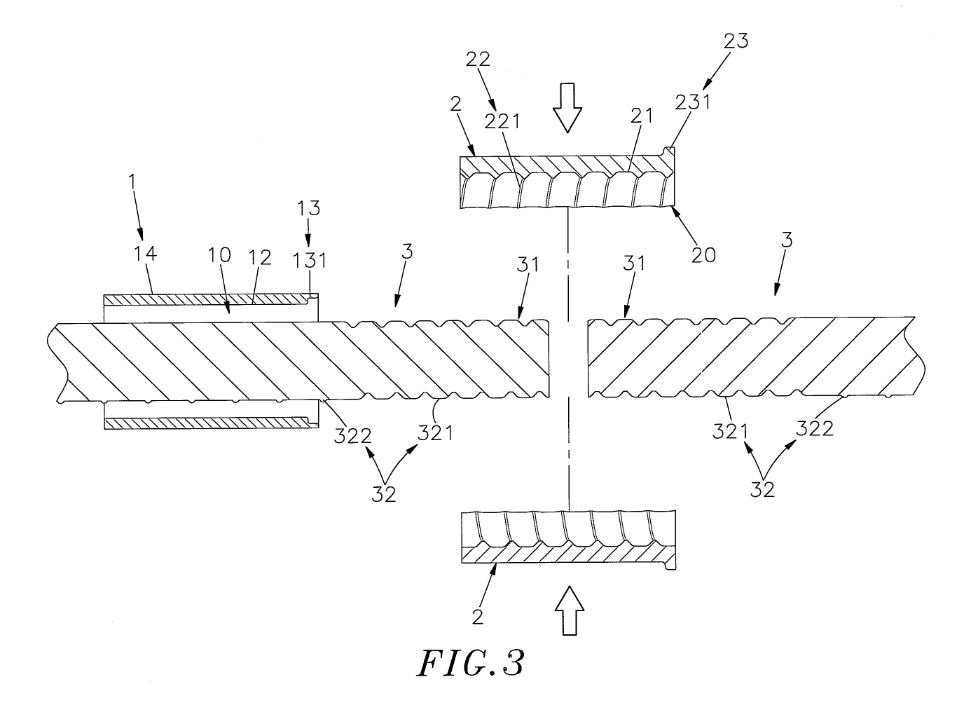

Referring to FIGS. 3˜6, during application of the steel bar connector, sleeve the socket 1 onto one reinforcing steel bar 3, and then abut the abutment end edges 31 of the two reinforcing steel bars 3 against each other, and then attach the two adapter members 2 to the two reinforcing steel bars 3 to force the inner threads 221 of the two adapter members 2 into engagement with the outer threads 321 of one reinforcing steel bar 3, and then move the socket 1 onto the two adapter members 2 to force the longitudinal ribs 11 into the gap between one respective side edge 20 of each of the two adapter members 2 and to have the two adapter members 2 be respectively accommodated in the longitudinal half-round grooves 12 of the socket 1. When one end of the socket 1 is kept in flush with the respective ends of the adapter members 2, the positioning blocks 231 of the adapter member 2 are engaged with the respective positioning grooves 131 of the socket 1. Thus, the installation is done. Subject to engagement between the female engagement means 22 of the adapter members 2 and the outer threads 321 of rib patterns 32 of the two reinforcing steel bars 3, the two reinforcing steel bars 3 are firmly secured together by the steel bar connector. Thus, the steel bar connector has the advantage of simple structure, ease of installation and low installation cost. After installation, the whole structure has the characteristics of high friction resistance, high tensile strength and high seismic resistance.

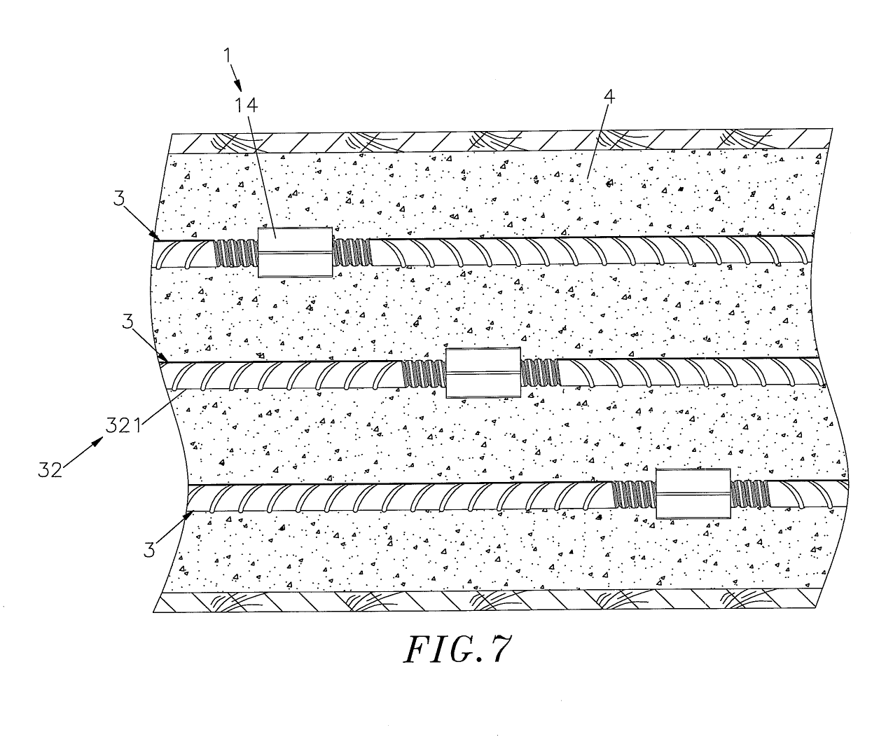

Referring to FIG. 7, multiple pairs of reinforcing steel bars are joined in lines by steel bar connectors and embedded in concrete 4 in a mold, forming a building construction.

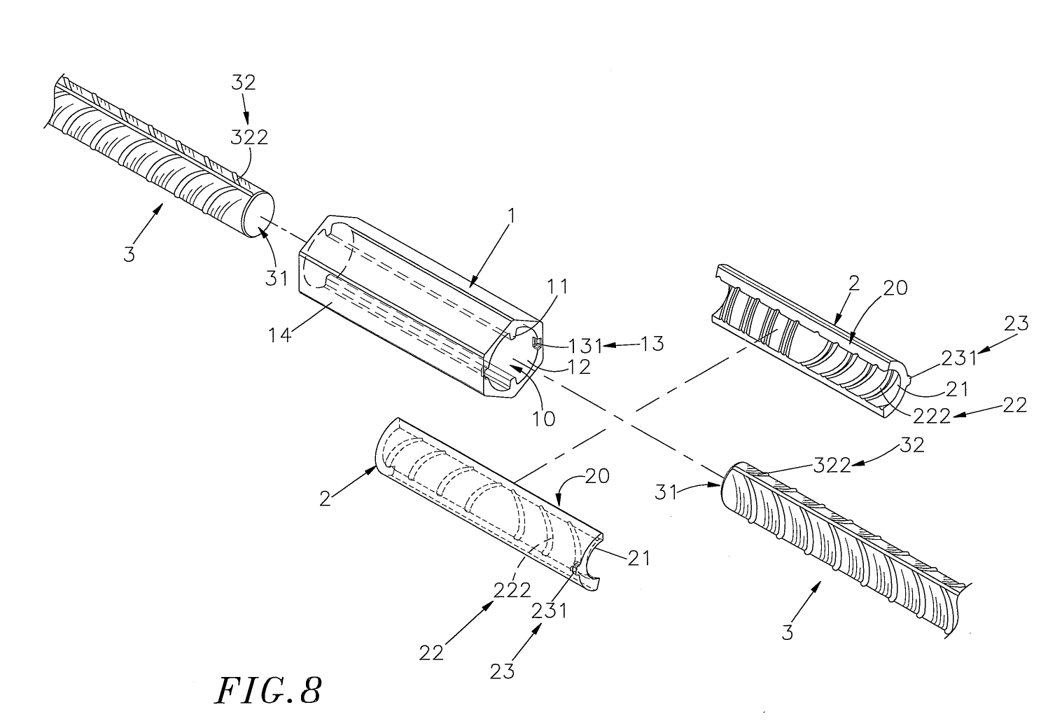

In an alternate form of the present invention, as shown in FIG. 8, the female engagement means 22 of each adapter member 2 comprises a plurality of engagement grooves 222 for engagement with the ribs 322 of the rib patterns 32 of the two reinforcing steel bars 3.

The present invention has the technical features that the adapter members 2 are respectively attached to the reinforcing steel bars 3 around the abutment end edges 31 to keep the female engagement means 22 of the adapter members 2 in engagement with the rib patterns 32 of the two reinforcing steel bars 3, the socket 1 is sleeved onto the adapter members 2 around the abutment end edges 31 of the two reinforcing steel bars 3 to keep each longitudinal rib 11 in the gap between one respective side edge 20 of each of the two adapter members 2 and to have the two adapter members 2 be respectively accommodated in the longitudinal half-round grooves 12 of the socket 1. Further, the steel bar connector has the advantages of simple structure, ease of installation and low installation cost. After installation, the combination structure of the steel bar connector and the reinforcing steel bars 3 has the characteristics of high friction resistance, high tensile strength and high seismic resistance.

In conclusion, the invention provides a steel bar connector for joining two reinforcing steel bars 3 in line, which has the advantages and features as follows:

1. When the socket 1 is sleeved onto the adapter members 2 around the abutment end edges 31 of the reinforcing steel bars 3, each longitudinal rib 11 of the socket 1 is engaged into the gap between one respective side edge 20 of each of the two adapter members 2, the male positioning means 23 of the two adapter members 2 are kept in engagement with the respective female positioning means 13 of the socket 1, and the female engagement means 22 of the adapter members 2 are kept in engagement with the rib patterns 32 of the reinforcing steel bars 3, and therefore the combination structure of the steel bar connector and the reinforcing steel bars 3 has the characteristics of high friction resistance, high tensile strength and high seismic resistance.
2. By means of attaching the adapter members 2 to the reinforcing steel bars 3 around the abutment end edges 31 to keep the female engagement means 22 in engagement with the rib patterns 32 of the reinforcing steel bars 3, and then attaching the socket 1 onto the adapter members 2 to force the respective female positioning means 13 into engagement with the female engagement means 22 of the adapter members 2, the installation is done. Therefore, the installation of the present invention is simple and easy, saving much installation time and labor.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A steel bar connector for joining two reinforcing steel bars that are abutted end-to-end against each other, the steel bar connector comprising:
two adapter members for attaching to the two reinforcing steel bars, each said adapter member comprising an arched inner wall fitting the periphery of the two reinforcing steel bars, female engagement means located on said arched inner wall and male positioning means located on one end of an outside wall thereof; and
a socket for attaching onto said adapter members to hold down said adapter members and said two reinforcing steel bars together, said socket comprising a longitudinal receiving open chamber extending through opposing front and rear sides thereof, two opposing longitudinal ribs protruded from an inside wall thereof within said longitudinal receiving open chamber, two longitudinal half-round grooves defined in said longitudinal receiving open chamber and separated by said longitudinal ribs and adapted for accommodating said adapter members respectively and female positioning means located on one end of each of said two longitudinal half-round grooves for engagement with the male positioning means of each of said adapter members.

2. The steel bar connector as claimed in claim 1, wherein each said female positioning means of said socket is a positioning groove; the male positioning means of each said adapter member is a positioning block fitting the positioning groove of the respective female positioning means of said socket.

3. The steel bar connector as claimed in claim 1, wherein said socket is a polygonal member comprising a plurality of faces around the periphery thereof.

4. The steel bar connector as claimed in claim 1, wherein the female engagement means of each said adapter member comprises a plurality of inner threads for engagement with outer threads at each of the two reinforcing steel bars.

5. The steel bar connector as claimed in claim 1, wherein the female engagement means of each said adapter member comprises a plurality of engagement grooves for engagement with ribs of a rib pattern at each of the two reinforcing steel bars.

6. The steel bar connector as claimed in claim 1, wherein each said adapter member comprises two opposing side edges; the longitudinal ribs of said socket are respectively engaged into the gap between one respective side edge of each of said two adapter members.
